(19) United States
(12) Patent Application Publication
(10) Pub. No.: US 2017/0022754 A1
(43) Pub. Date: Jan. 26, 2017

(54) SEPARABLE TILTING DEVICE

(71) Applicant: NIEN MADE ENTERPRISE CO., LTD., Taichung City (TW)

(72) Inventors: Chao-Hung NIEN, Taichung City (TW); Chih-Yao CHANG, Taichung (TW); Wei-Xue YUAN, Taichung (TW)

(21) Appl. No.: 15/215,366

(22) Filed: Jul. 20, 2016

(30) Foreign Application Priority Data
Jul. 24, 2015 (CN) 201520544088.3

(51) Int. Cl. E06B 9/307; E06B 9/32; F16H 1/16

(52) U.S. Cl. CPC E06B 9/307; F16H 1/16; E06B 9/32; E06B 2009/285

(57) ABSTRACT

A separable tilting device includes a case, a first driving member, a second driving member, and a connector. The first driving member and the second driving member are provided in a chamber of the case, and are movable by each other. The connector is connected to the first driving member, wherein the connector has an engaging slot. An end of a stop member of the case extends into the engaging slot, so that the connector could not be disengaged from the first driving member. An end of the connector is controllable to rotate the first driving member. Whereby, the first driving member and the second driving member are completely hidden inside the case, which prevents the tilting device or slats of a window covering from being damaged.

The current application claims a foreign priority to application number 201520544088.3 filed on Jul. 24, 2015 in China.

### BACKGROUND OF THE INVENTION

1. Technical Field

The present invention generally relates to structures of window coverings, and more particularly to a separable tilting device, which could be installed on one's own to prevent the slats from being deformed.

2. Description of Related Art

Titling devices are commonly used in window coverings to control and adjust the tilt angle of slats, and therefore to change the amount of light which could pass through. A conventional tilting device mainly includes a worm gear and a worm. As disclosed in U.S. Pat. No. 4,406,319, titled “Venetian blind drive control”, and U.S. Pat. No. 4,947,921, titled “Lift lock and tilt device for a Venetian blind”, the worm gear is rotatably provided in a case, which is provided in a headrail of a window covering. An end of the worm engages with the worm gear, and is located in the case, while another end thereof extends out of the case and the headrail, so that a hook or a rod could be easily assembled thereto. The purpose of providing the hook or the rod is to connect a wand, which is adapted to be manipulated to rotate the worm. The tilt angle of the slats could be adjusted in this way.

The worm gear and the worm described above are assembled and positioned in the case before rolling out of the factory. In other words, an end user may not be able to assemble these components on his own; instead, an end user could only adjust the tilt angle of the slats through such hook or rod. Also, the worm extends out of an end of the headrail, and may press the uppermost slat when the product is packed in a box, which could deform or damage the slats. Furthermore, the worm could be broken due to collisions during the delivery. Therefore, the conventional tilting device still has room for improvement.

### BRIEF SUMMARY OF THE INVENTION

In view of the reasons mentioned above, the primary objective of the present invention is to provide a separable tilting device, which prevents the tilting device or the slats of the window coverings from being damaged.

The present invention provides a separable tilting device, which includes a case, a first driving member, a second driving member, and a connector. The case has a chamber therein, wherein the case further has at least one first opening, a second opening, and a stop member; the first opening and the second opening communicate with the chamber; an end of the stop member is connected to a peripheral edge of the first opening, while another end thereof extends into the second opening toward the chamber. The first driving member and the second driving member are provided in the chamber of the case, and are movable by each other. The connector is independent from the case, the first driving member, and the second driving member, wherein the connector comprises a first end and a second end opposite to the first end, and has an engaging slot located between the first end and the second end; the connector passes through the second opening of the case, with the first end thereof located in the case to be connected to the first driving member, while the second end thereof is controllable to rotate the first driving member; the end of the stop member of the case extending toward the chamber is engaged in the engaging slot.

In an embodiment, the first driving member comprises a worm, and the second driving member comprises a worm gear. The worm and the worm gear mesh together, and are movable by each other.

In an embodiment, the worm has an engaging portion. The connector is a rod, wherein the first end thereof has a receiving hole, which is engaged with the engaging portion of the worm with a non-circular surface thereof.

In an embodiment, the engaging portion of the worm has an undulating surface, and the surface of the receiving hole of the connector is also undulating to be engaged with the engaging portion.

In an embodiment, the engaging portion of the worm has a plurality of protrusions arranged separately on a surface thereof. The connector has a plurality of cuts on the first end thereof communicating with the receiving hole. Each of the protrusions of the engaging portion of the worm fit into one of the cuts.

In an embodiment, the separable tilting device further comprises a hook and a sleeve, wherein the connector has an insertion hole provided in a radial direction thereon. An end of the hook is inserted into the insertion hole, while another end thereof is hooked. The sleeve fits around the connector to cover the insertion hole, whereby the hook is restricted from being disengaged from the connector.

In an embodiment, the second end of the connector has a hooking hole adapted to be engaged with a wand which has a hook.

In an embodiment, the connector has a slot wall provided in the engaging slot to correspond to the end of the stop member which extends into the engaging slot, so that the end of the stop member extending into the engaging slot abuts against the slot wall.

In an embodiment, the engaging slot is a circular slot.

With the aforementioned design, the first driving member and the second driving member are hidden inside the case, and the connector could be inserted into the case to connect the first driving member by an end user while installing the window covering. In this way, the slats of the window covering could be prevented from being damaged or deformed during the delivery.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a first embodiment of the present invention;

FIG. 2 is an exploded view of the first embodiment of the present invention mentioned above;

FIG. 3 is a sectional view of the first embodiment of the present invention mentioned above;

FIG. 4 is a sectional view along the 4-4 line in FIG. 3;

FIG. 5 is a perspective view of a second embodiment of the present invention;

FIG. 6 is an exploded view of the second embodiment of the present invention mentioned above;

FIG. 7 is a sectional view of the second embodiment of the present invention mentioned above; and

FIG. 8 is a sectional view along the 3-3 line in FIG. 7.

### DETAILED DESCRIPTION OF THE INVENTION

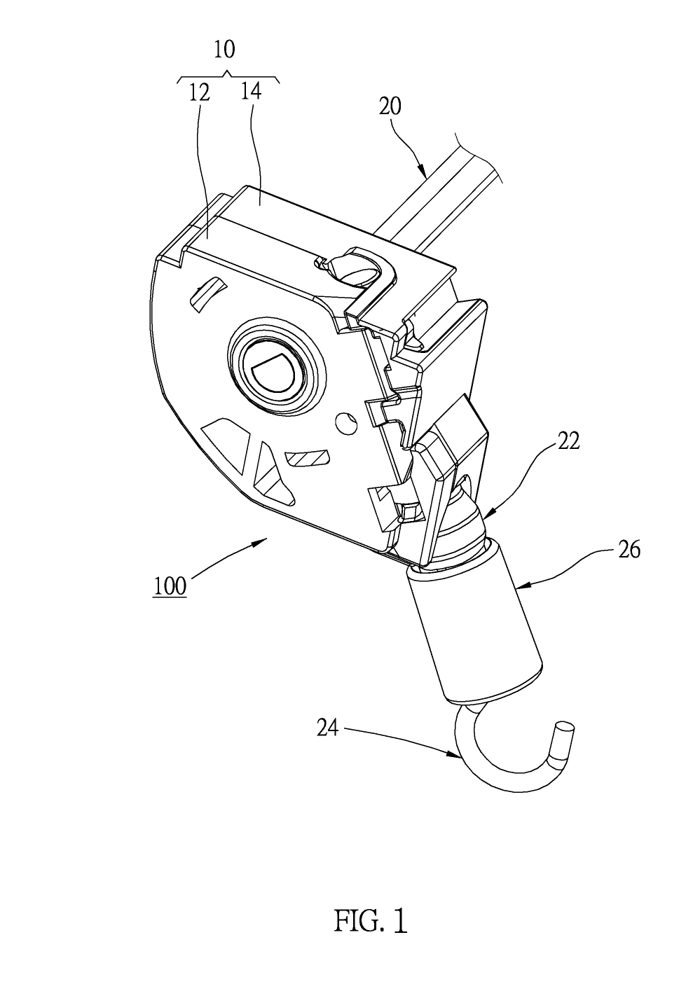

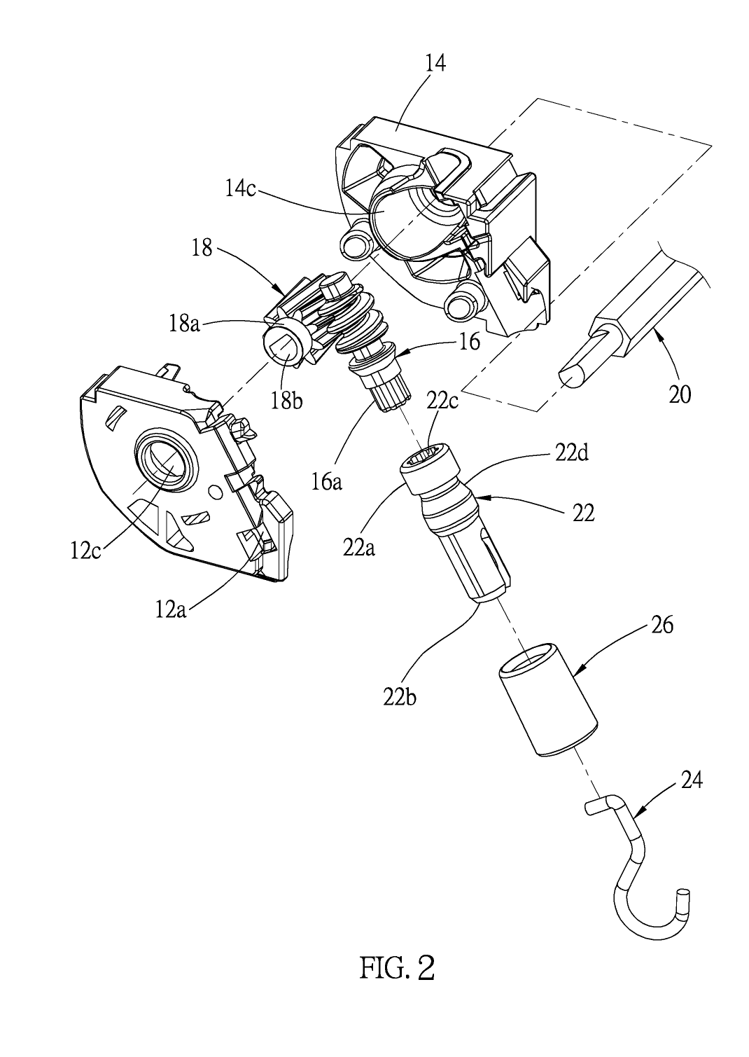

As shown in FIG. 1 to FIG. 4, a separable tilting device 100 of a first embodiment of the present invention is installed in a headrail T of a window covering. The separable tilting device 100 includes a case 10, a first driving member, a second driving member, a connector 22, a hook 24, and a sleeve 26.

The case 10 includes two sub-cases 12, 14 made of plastic, wherein the sub-cases are combined to form a chamber therebetween. A first opening 12a (14a), a stop member 12b (14b), and a lateral bore 12c (14c) are integrally formed on each of the sub-cases, wherein the first opening 12a (14a) and the lateral bore 12c (14c) communicate with the chamber. The stop member 12b (14b) is integrally connected to a peripheral edge of the first opening 12a (14a), with an end thereof extending toward the chamber. In addition, a second opening 10a is formed on a bottom of the combined sub-cases 12, 14, wherein the second opening 10a also communicates with the chamber.

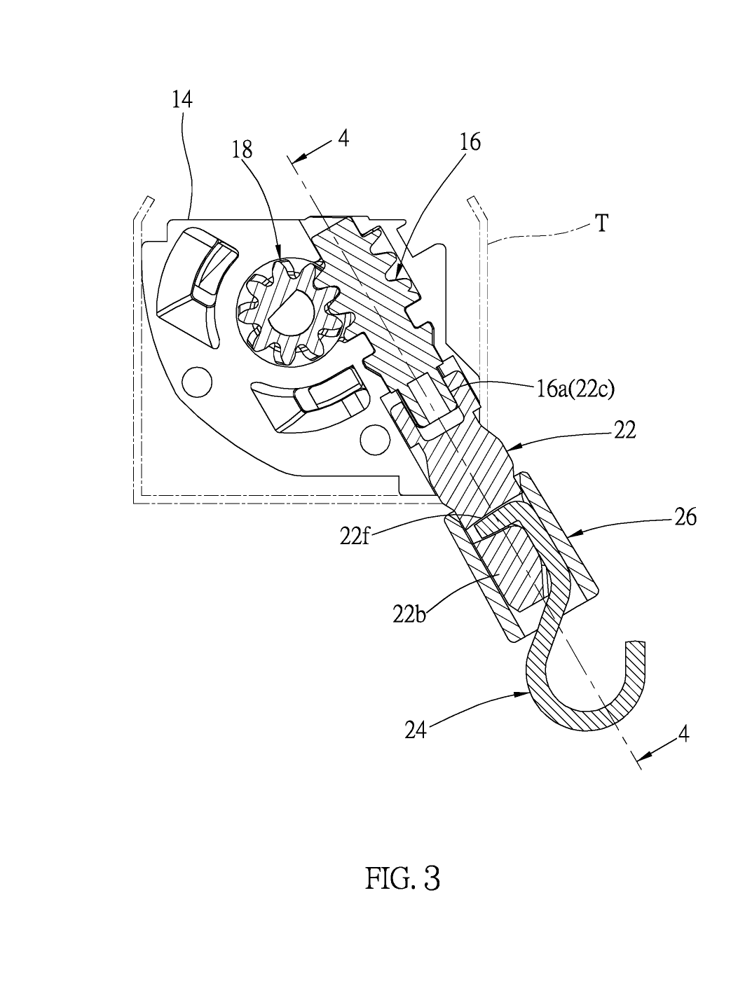

The first driving member and the second driving member are provided in the chamber of the case 10, and are movable by each other. In the first embodiment, the first driving member is a worm 16, and the second driving member is a worm gear 18. A part of the worm 16 is a helical structure, another part of the worm 16 is an engaging portion 16a, which has an undulating surface, and is non-circular. Each of two posts 18a on both sides of the worm gear 18 extends into one of the lateral bores 12c (14c) of the sub-cases 12, 14, respectively, so that the worm gear 18 is rotatable at its location. The worm gear 18 further has a non-circular axial bore 18b, which is adapted for an end of a shaft 20 to be inserted therein, whereby the worm gear 18 could be rotated along with the shaft 20. As shown in FIG. 3, after assembling, the helical structure of the worm 16 meshes with the worm gear 18, so that the worm 16 and the worm gear 18 are movable by each other. The worm 16 is completely hidden inside the case 10.

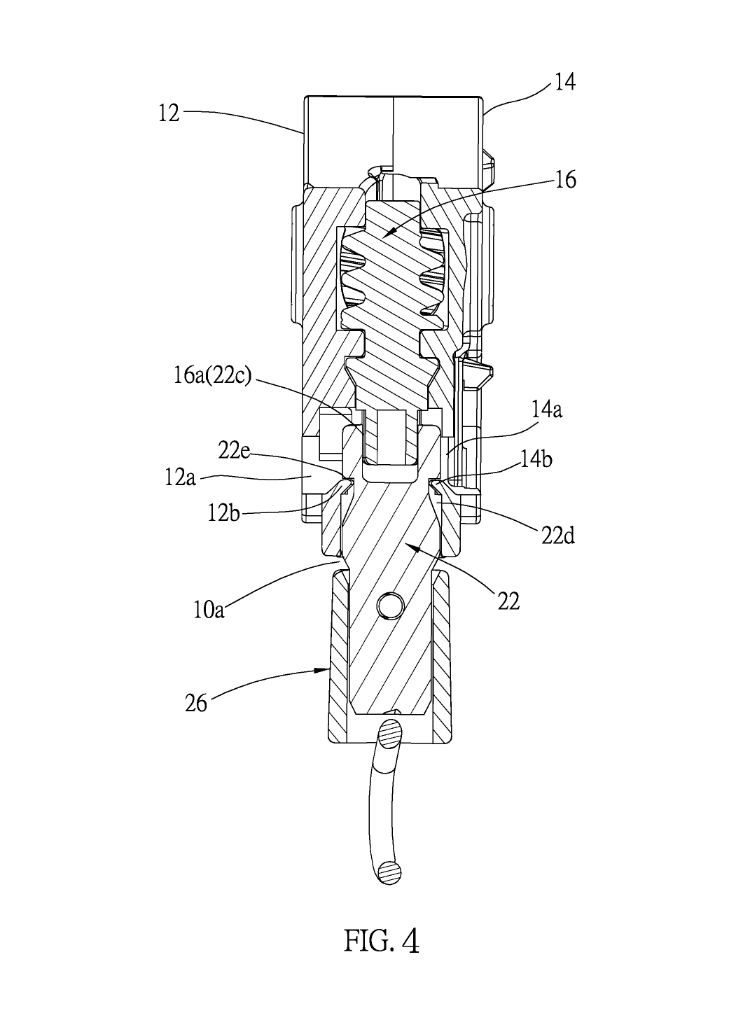

As shown in FIG. 3 and FIG. 4, the connector 22 is formed by a rod-like member, which has a first end 22a and a second end 22b opposite to the first end 22a. The connector 22 has a receiving hole 22c recessed from an end surface of the first end 22a, and an engaging slot, which is a circular slot 22d, located between the first end 22a and the second end 22b. An insertion hole 22f is further provided below the circular slot 22d in a radial direction thereof, wherein the insertion hole 22f is adapted for an end of the hook 24 to be inserted therein, of which another end is formed by a hook-shaped part. The sleeve 26 fits around a lower segment of the connector 22 to cover the insertion hole 22f, whereby the hook 24 is restricted from disengaging from the connector 22.

In the first embodiment, a wall of the receiving hole 22c also has an undulating surface corresponding to the engaging portion 16a, so that the connector 22 could smoothly fit around the engaging portion 16a with the receiving hole 22c after the first end 22a passes through the second opening 10a of the case 10. Furthermore, the engaging portion 16a and the receiving hole 22c are engaged together with their non-circular surfaces, so that the worm 16 and the connector 22 could be rotated synchronously. As shown in FIG. 3, after assembling, the second end 22b of the connector 22 extends out of the case 10, and is exposed out of the headrail T.

As shown in FIG. 4, during the process of engaging the connector 22 and the worm 16, an outer wall of the connector 22 abuts against the stop member 12b (14b) of each of the sub-cases first, which pushes outward and deforms the stop members 12b (14b). Once the connector 22 and the worm 16 are engaged together, each of the stop members 12b (14b) would return to its original status, and has an end thereof extending into the circular slot 22d. As a result, the connector 22 would not be easily disengaged from the worm 16. In the first embodiment, the circular slot 22d further has a slot wall 22e substantially parallel to the radial direction. An end of the stop member 12b (14b) abuts against the slot wall 22e, so that it could ensure that the connector 22 would not be disengaged from the worm 16 after assembling. The purpose of providing the hook 24 mentioned above is to connect a wand (not shown). By rotating the wand, the worm 16 could be indirectly rotated through the connector 22 to adjust the tilt angle of slats of the window covering.

In the first embodiment, the worm 16 and the worm gear 18 are completely hidden inside the case 10, and the connector 22 is an independent component, which could be engaged to the worm 16 by the end user who bought the related product for the window covering. Therefore, the problem of a conventional tilting device, that an end of the worm extends out of the headrail, is solved, which not only prevents the slats of the window covering from being damaged or deformed, but also keeps the worm 16 intact by hiding it inside the case 10.

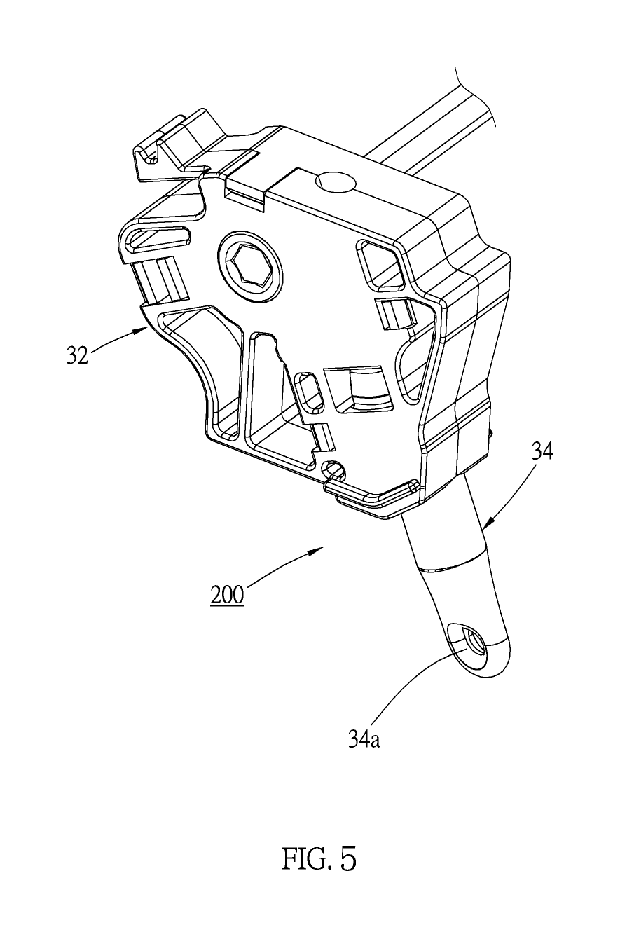

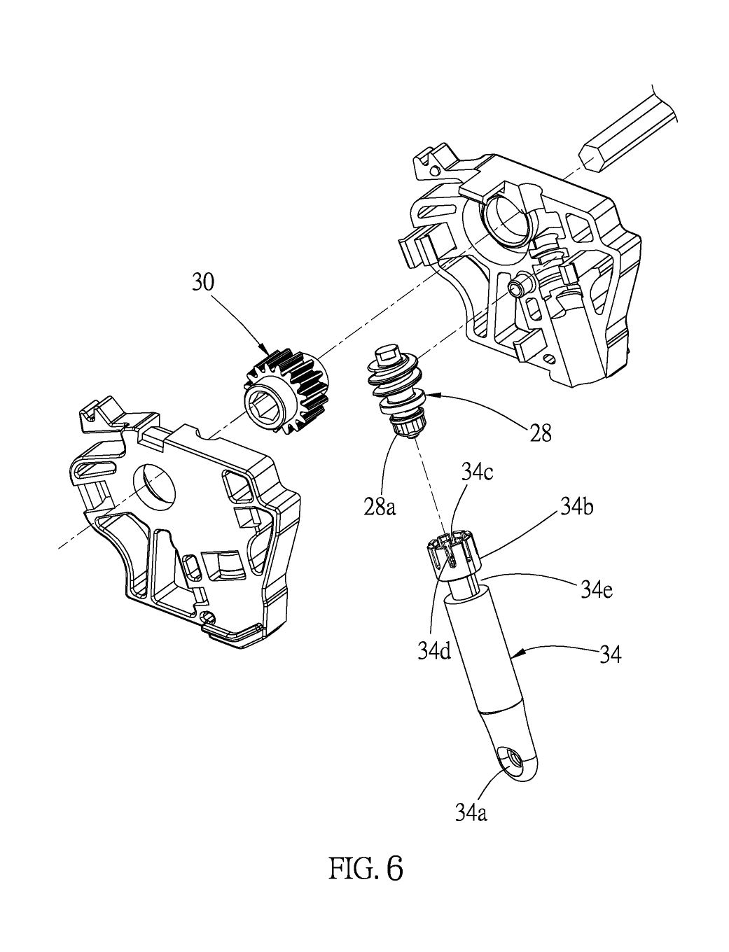

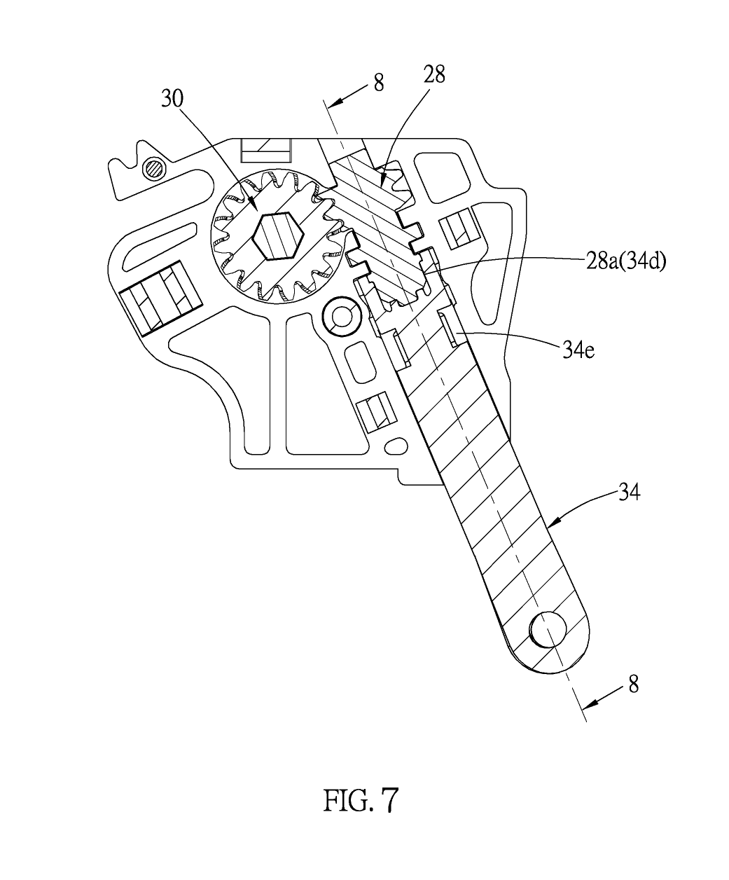

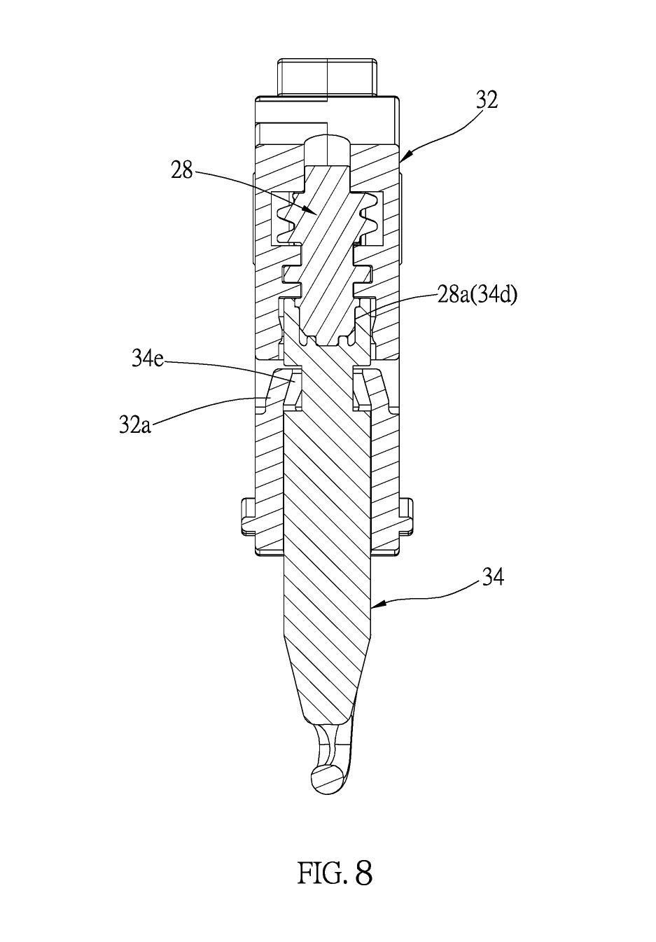

A separable tilting device 200 of the second embodiment of the present invention is illustrated in FIG. 5 to FIG. 8, which include most of the components of that of the first embodiment, wherein a worm 28 and a worm gear 30 are also completely hidden inside a case 32. The difference between the first and the second embodiment is that, the separable tilting device 200 does not include a hook and a sleeve, and a connector 34 thereof is a long rod, which has a hooking hole 34a on an end (i.e., the second end) thereof, wherein the hooking hole 34a is adapted to be engaged with a wand having a hook.

The connector 34 has a plurality of cuts 34d on a first end 34b thereof, wherein the plurality of cuts 34d communicate with a receiving hole 34c. An engaging portion of the worm 28 has a plurality of protrusions 28a arranged evenly and separately thereon. After assembling, each of the protrusions 28a of the worm 28 fits into the corresponding cut 34d. The worm 28 and the connector 34 are also engaged together with non-circular surfaces, and therefore could be rotated synchronously. In addition, a body of the connector 34 has a circular slot 34e below the receiving hole 34c. Each of stop members 32a of the case 32 has an end thereof extending into the circular slot 34e, so that the connector 34 could not be disengaged from the worm 28. Similarly, when the separable tilting device 200 is packed for selling, the slats of the window covering could be prevented from being damaged or deformed.

Also, since the plurality of cuts 34d on the first end 34b of the connector 34 are adapted to be fitted by the protrusions 28a of the worm 28, when the wand is connected to the aforementioned hooking hole 34a to rotate the worm 28, a shaft 20 could be rotated by the worm gear 30. However, if the tilt angle of the slats of the window covering reaches a possible limit, and the aforementioned wand is continuously rotated, the first end 34b of the connector 34 could be slightly deformed outward due to the plurality of cuts 34d. At this time, the worm 28 could not be further rotated due to reach a limit if the connector 34 is still continuously rotated by the end user through the wand, which could also prevent the damage of the hooking hole 34a by the still-rotating wand.

It must be pointed out that the embodiments described above are only some preferred embodiments of the present invention. All equivalent structures which employ the concepts disclosed in this specification and the appended claims should fall within the scope of the present invention.

What is claimed is:

1. A separable tilting device, comprising:
a case having a chamber therein, wherein the case further has at least one first opening, a second opening, and a stop member; the first opening and the second opening communicate with the chamber; an end of the stop member is connected to a peripheral edge of the first opening, while another end thereof extends into the second opening toward the chamber;
a first driving member and a second driving member provided in the chamber of the case, which are movable by each other; and
a connector, which is independent from the case, the first driving member, and the second driving member, wherein the connector comprises a first end and a second end opposite to the first end, and has an engaging slot located between the first end and the second end; the connector passes through the second opening of the case, with the first end thereof located in the case to be connected to the first driving member, while the second end thereof is controllable to rotate the first driving member; the end of the stop member of the case extending toward the chamber is engaged in the engaging slot.

2. The separable tilting device of claim 1, wherein the first driving member comprises a worm, and the second driving member comprises a worm gear; the worm and the worm gear mesh together, and are movable by each other.

3. The separable tilting device of claim 2, wherein the worm has an engaging portion; the connector is formed by a rod-like member, of which the first end has a receiving hole, which is engaged with the engaging portion of the worm with a non-circular surface thereof.

4. The separable tilting device of claim 3, wherein the engaging portion of the worm has an undulating surface, and the surface of the receiving hole of the connector is also undulating to be engaged with the engaging portion.

5. The separable tilting device of claim 3, wherein the engaging portion of the worm has a plurality of protrusions arranged separately on a surface thereof; the connector has a plurality of cuts on the first end thereof communicating with the receiving hole; each of the protrusions of the engaging portion of the worm fit into one of the cuts.

6. The separable tilting device of claim 3, further comprising a hook and a sleeve, wherein the connector has an insertion hole provided in a radial direction thereon; an end of the hook is inserted into the insertion hole, while another end thereof is formed by a hook-shaped part; the sleeve fits around the connector to cover the insertion hole, whereby the hook is restricted from being disengaged from the connector.

7. The separable tilting device of claim 3, wherein the second end of the connector has a hooking hole.

8. The separable tilting device of claim 1, wherein the connector has a slot wall provided in the engaging slot to correspond to the end of the stop member which extends into the engaging slot, so that the end of the stop member extending into the engaging slot abuts against the slot wall.

9. The separable tilting device of claim 1, wherein the engaging slot is a circular slot.

10. The separable tilting device of claim 8, wherein the engaging slot is a circular slot.
